(19) United States
(12) Patent Application Publication
(10) Pub. No.: US 2011/0175482 A1
(43) Pub. Date: Jul. 21, 2011

(54) OPTIMIZED STATOR TOOTH TIP FOR A MOTOR WITH AXIALLY INSERTED STATOR WINDINGS

(76) Inventors: Peter J. Savagian, Bloomfield Hills, MI (US); Edward L. Kaiser, Orion, MI (US); Khwaja M. Rahman, Troy, MI (US)

(21) Appl. No.: 12/690,148

(22) Filed: Jan. 20, 2010

(51) Int. Cl. H02K 3/12; H02K 1/16

(52) U.S. Cl. 310/201; 310/216.096

(57) ABSTRACT

An electric motor includes a rotor and a stator assembly concentrically located about the rotor. The stator assembly includes a stator stack and a plurality of spaced apart stator teeth extending radially from the stator stack. The plurality of stator teeth defines a plurality of stator slots. Each stator tooth defines a stator tooth tip. The stator tooth tips are shaped to reduce the magnetic flux generated by the stator assembly during operation of the electric motor

### TECHNICAL FIELD

The present invention relates, generally, to a stator for an electric motor, and more specifically, to a tooth tip for the stator of the electric motor.

### BACKGROUND OF THE INVENTION

Electric motors include stator assemblies which have conductors for the motor. A stator stack for the stator assembly includes teeth that extend radially from the stator stack. The conductors are inserted into slots defined by the spaced apart stator teeth.

When the electric motor is operating, magnetic flux is generally guided toward the rotor from the stator and vice-versa by the stator teeth. However, as is widely known by someone familiar with electric machines, the presence of the alternating stator teeth and slots introduces slotting effects. The slotting effects include unnecessary flux variations as the rotor rotates, which is a major source of torque ripple and iron loss in an electric machine. Both of these are undesirable and a machine designer tries to minimize both the effects. One way to mitigate these effects is to add a magnetic material similar to that of the stator stack in the form of a wedge and insert the wedge into the slots between the teeth at the radial endings of the conductors. The wedges minimize the undesirable flux variations resulting from the stator teeth as the rotor rotates. However, adding separate wedges into every stator slots is a difficult manufacturing process. As a consequence is rarely implemented in any final product.

### SUMMARY OF THE INVENTION

An electric motor includes a rotor and a stator assembly concentrically located about the rotor. The stator assembly includes a stator stack and a plurality of spaced apart stator teeth extending radially from the stator stack. The plurality of stator teeth defines a plurality of stator slots. Each stator tooth defines a stator tooth tip. The stator tooth tips are integrally formed with the stator teeth and are given geometric shapes which reduce the magnetic flux variations generated by the stator assembly during operation of the electric motor.

A method of reducing magnetic flux variation for a stator assembly includes forming a plurality of stator tooth tips on a plurality of stator teeth for a stator stack. The stator tooth tips are formed to minimize a gap within a stator slot, located between the stator teeth and a plurality of conductors.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a rotor and a stator assembly of the prior art;

FIG. 2 is a partial schematic cross-sectional view of the rotor and the stator assembly of the prior art, illustrating the magnetic flux that is generated by stator teeth of the stator assembly;

FIG. 3 is a schematic cross-sectional view of a first embodiment of a rotor and a stator assembly;

FIG. 4 is a partial schematic cross-sectional view of the first embodiment of a stator assembly showing a first plurality of stator teeth;

FIG. 5 is a partial schematic cross-sectional view of a second embodiment of a stator assembly showing a second plurality of stator teeth;

FIG. 6 is a partial schematic cross-sectional view of a third embodiment of a stator assembly showing a third plurality of stator teeth; and

FIG. 7 is a partial schematic cross-sectional view of a fourth embodiment of a stator assembly showing a fourth plurality of stator teeth.

### DESCRIPTION OF THE PREFERRED EMBODIMENTS

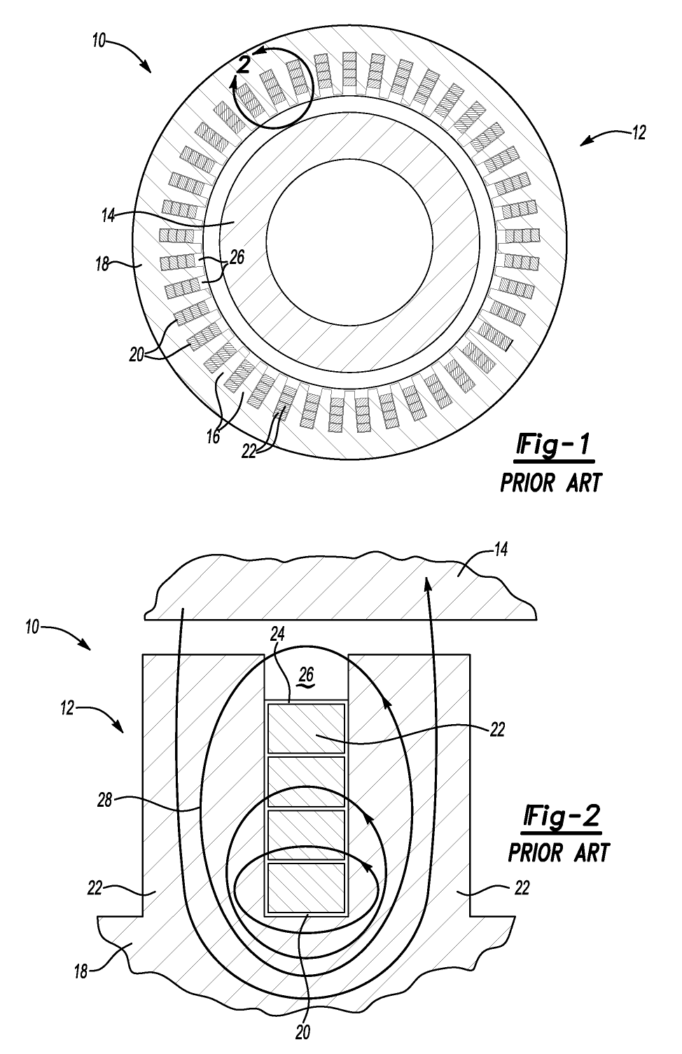

Referring to the Figures, wherein like reference numbers refer to the same or similar components throughout the several views, FIGS. 1 and 2 partially schematically illustrate an electric motor 10 of the prior art having a stator assembly 12 and a rotor 14. The stator assembly 12 includes a plurality of stator teeth 16. The stator teeth 16 extend radially from a stator stack 18 and are spaced apart to form stator slots 20. A plurality of conductors 22 are inserted within the stator slots 20 and are surrounded by a stator slot liner 24.

When stator windings (the plurality of conductors 22) are excited with current, stator flux 28 is produced. Certain portions of the stator flux 28 crosses the air gap and links with the rotor 14 which produces torque. However, another portion of the stator flux 28, usually called the leakage flux, circulates around the stator teeth 16 and slot 20. This leakage flux does not cross the air gap and, therefore, does not contribute to the generation of the torque. Therefore, it is desirable to minimize both the leakage flux and the flux variation between the rotor and the stator, known as the slotting effect. As the rotor speed increases the frequency of this slotting effect caused by the stator flux 28 and rotor flux is also increased.

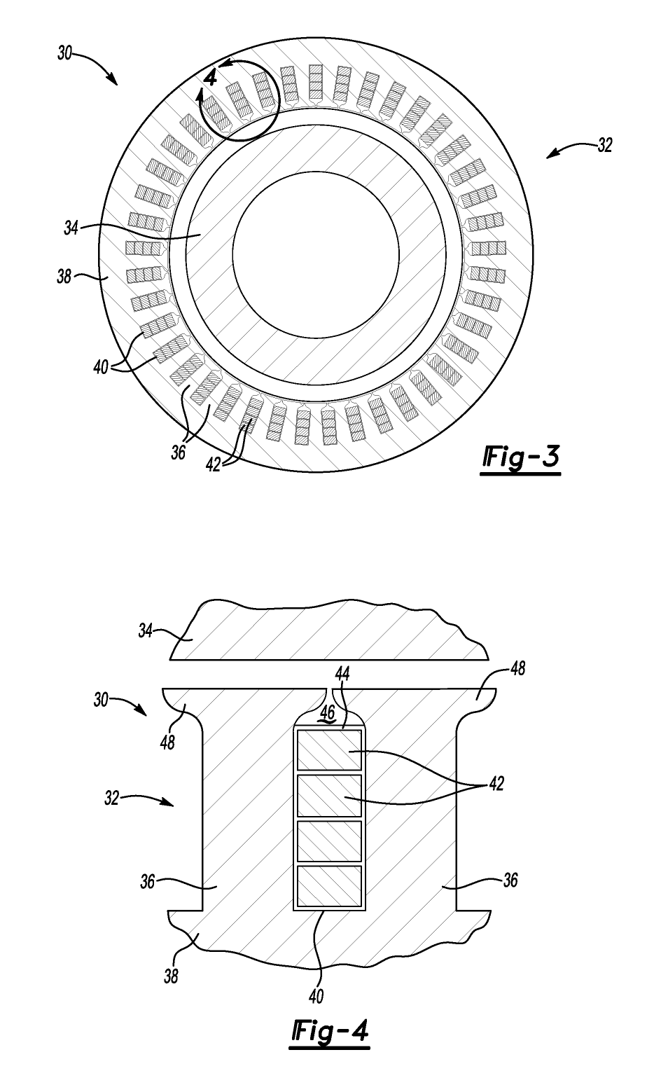

FIG. 3 is a partial schematic perspective illustration of a first embodiment of an electric motor 30 having a stator assembly 32 and a rotor 34. The stator assembly 32 includes a plurality of stator teeth 36. The stator teeth 36 extend radially from a stator stack 38 and are spaced apart to form stator slots 40. A plurality of conductors 42 are inserted within the stator slots 40 from the axial end of the stator stack 38. The conductors 42 are surrounded by a stator slot liner 44 (shown in FIG. 4). The conductors 42 are illustrated as square wire conductors 42 but may have other cross-sectional shapes.

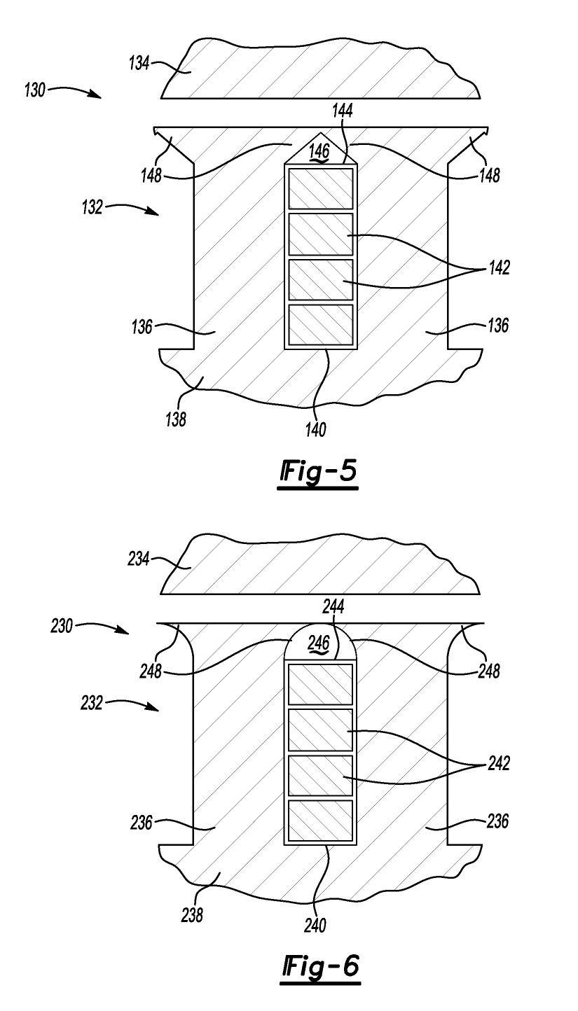

Referring to FIG. 4, each of the stator teeth 36 has at least one stator tip 48 integrally formed therewith. A space may be located between adjacent stator teeth tips 48 to form open stator slot 40, as shown, or the adjacent stator teeth tips 48 may be touching, to form a closed stator slot (shown in FIG. 5). In either embodiment a gap 46 within the stator slot 40 remains unfilled after the conductors 42 have been inserted within the stator slot 40.

In the embodiment shown, the stator tips 48 have a parabolic curve on their sides. The stator tips 48 are shaped to reduce the size of the gap 46 within the stators slots 40. However, at the radial ends of each stator tooth 36 the stators tips 48 are still spaced apart from one another, to form open stator slots 40. The shape of the stator tips 48 may be formed to optimize the amount of magnetic flux and the slotting effect that occurs. By optimizing the shape of the stator tips 48 the stator assembly 32 may be tuned for a particular electric motor 30 configuration or application. The reduction in slotting effect results in smoother rotation of the rotor 34 and a more efficient electric motor 30.

FIG. 5 illustrates a second embodiment of an electric motor 130 having a stator assembly 132 and a rotor 134. The stator assembly 132 includes a plurality of stator teeth 136. The stator teeth 136 extend radially from a stator stack 138 and are spaced apart to form stator slots 140. A plurality of conductors 142 are inserted within the stator slots 140 from the axial end of the stator stack 138. The conductors 142 are surrounded by a stator slot liner 144. The conductors 142 are illustrated as square wire conductors 142 but may have other cross-sectional shapes. A gap 146 within the stator slots 140 remains unfilled after the conductors 142 and the slot liner 144 are inserted.

Each of the stator teeth 136 has at least one stator tip 148 integrally formed therein. In the embodiment shown, the stator tips 148 are straight surfaces extending from the stator teeth 136 and are touching to form a closed stator slot 140. A gap 146 remains after the conductors 142 have been inserted within the closed stator slot 140. The stator tips 148 are shaped to reduce the size of the gap 146 of the stators slots 140. At the radial ends of each stator tooth 136, the stators tips 148 are contacting one another (or formed together), to form closed stator slots 140. The shape of the stator tips 148 may be formed to optimize the amount of magnetic flux that occurs. The stator tips 148 are shaped such that the stator slot 140 is closed while the thickness of the tooth tip 148 where the two tips join is small enough to reduce the leakage flux. Due to the closing of the stator slot 140 the slotting effect and its undesirable consequences, the torque ripple and iron loss, are greatly reduced. By optimizing the shape of the stator tips 148 the stator assembly 132 may be tuned for a particular electric motor 130 configuration or application. The reduction in magnetic flux results in smoother rotation of the rotor 134 and a more efficient electric motor 130. Additionally, the absolute torque output of the electric motor 130 is increased as a result of the decrease in torsional vibration of the rotor 134.

FIG. 6 illustrates a third embodiment of an electric motor 230 having a stator assembly 232 and a rotor 234. The stator assembly 232 includes a plurality of stator teeth 236. The stator teeth 236 extend radially from a stator stack 238 and are spaced apart to form stator slots 240. A plurality of conductors 242 are inserted within the stator slots 240 from the axial end of the stator stack 238. The conductors 242 are surrounded by a stator slot liner 244. The conductors 242 are illustrated as square wire conductors 242 but may have other cross-sectional shapes. A gap 246 within the stator slots 240 remains empty after the conductors 242 and the slot liner 244 are inserted.

Each of the stator teeth 236 has at least one stator tip 248 integrally formed therein. In the embodiment shown, the stator tips 248 are curved surfaces extending from the stator teeth 236 to form a generally semi-circular shaped gap 246 within the stator slot 240. At the radial ends of each stator tooth 236 the stators tips 248 are contacting one another, to form closed stator slots 240. The shape of the stator tips 248 may be formed to optimize the amount of magnetic flux leakage that occurs and minimize the slotting effect. By optimizing the shape of the stator tips 248 the stator assembly 232 may be tuned for a particular electric motor 230 configuration or application. The reduction in magnetic flux results in results in smoother rotation of the rotor 234 and a more efficient electric motor 230.

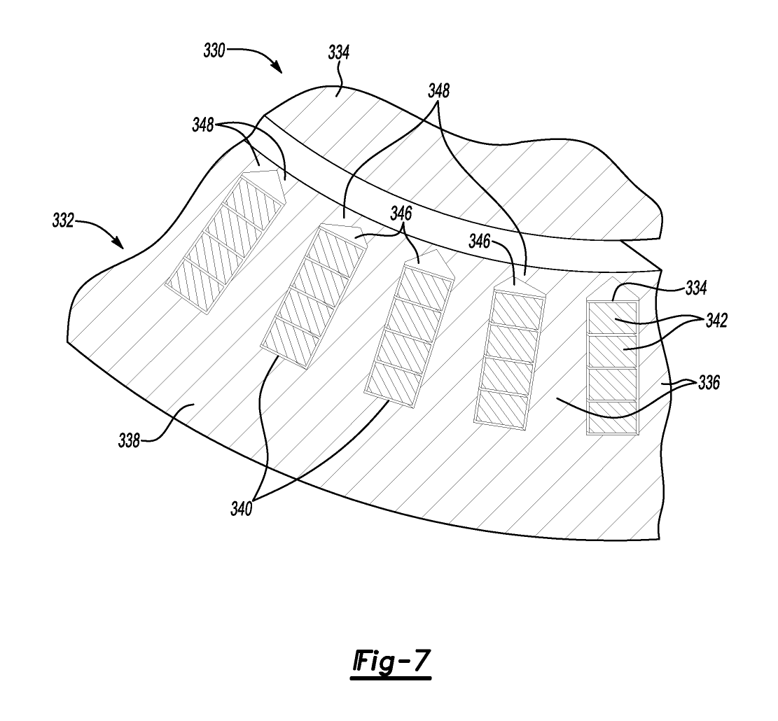

FIG. 7 illustrates a fourth embodiment of an electric motor 330 having a stator assembly 332 and a rotor 334. The stator assembly 332 includes a plurality of stator teeth 336. The stator teeth 336 extend radially from a stator stack 338 and are spaced apart to form stator slots 340. A plurality of conductors 342 are inserted within the stator slots 340 from the axial end of the stator stack 338. The conductors 342 are surrounded by a stator slot liner 344. The conductors 342 are illustrated as square wire conductors 342 but may have other cross-sectional shapes. A gap 346 within the stator slots 340 remains empty after the conductors 342 and the slot liner 344 are inserted.

Each of the stator teeth 336 has at least one stator tip 348 integrally formed therein. In the embodiment shown, the shapes of the stator tips 348 vary from one another to create differently shaped gap 346 for each stator slot 340. Additionally, adjacent stator tips 348 may have a different shape from one another to create an asymmetric gap 346 for a particular stator slot 340. The shape and variation for or the stator tips 348 may be random, or form a pattern. The stator tips 348 are shaped to reduce the size of the gaps 346 within the stators slots 340. At the radial ends of each stator tooth 336 the stators tips 348 are contacting one another, to form closed stator slots 340. The shape of the stator tips 348 may be formed to optimize the amount of leakage magnetic flux that occurs and minimize the slotting effect. By optimizing the shape of the stator tips 348 the stator assembly 332 may be tuned for a particular electric motor 330 configuration or application. The reduction in magnetic slotting effect results in smoother rotation of the rotor 334 and a more efficient electric motor 330.

As discussed by the embodiments above the shape of the stator tips 48, 148, 248, 348 may be determined to optimize the magnetic flux generated by the stator teeth 36, 136, 236, 336. Therefore, the stator tips 48, 148, 248, 348 may have straight surfaces and form open or closed stator slots 40, 140, 240, 340 or have a curved shape and form open or closed stator slots 40, 140, 240, 340. Additionally, the shapes of the stator tips 48, 148, 248, 348 may also vary from one another and/or form asymmetric gaps 46, 146, 246, 346 for the stator slots 40, 140, 240, 340. The embodiments above show several variations in the stator tips 48, 148, 248, 348 shapes. However, shapes other than those illustrated above may be utilized. One skilled in the art would know the best shape to use for a given application and configuration of an electric motor 30, 130, 230, 330.

While the best modes for carrying out the invention have been described in detail, those familiar with the art to which this invention relates will recognize various alternative designs and embodiments for practicing the invention within the scope of the appended claims.

1. An electric motor comprising:
a stator assembly including;
a stator stack;
a plurality of spaced apart stator teeth extending radially from the stator stack, wherein the plurality of stator teeth define a plurality of stator slots;
wherein the stator teeth each define a stator tooth tip, and wherein the stator tooth tips are integrally formed with the stator teeth and are shaped to reduce the magnetic flux generated by the stator assembly during operation of the electric motor; and
a plurality of conductors axially inserted within the stator slots.

2. The electric motor of claim 1, wherein adjacent stator tooth tips contact one another such that the respective stator slots are closed.

3. The electric motor of claim 2, wherein the stator tooth tips adjacent to one another have straight surfaces within the respective stator slots, and the surfaces contact each other to form respective generally triangular shaped gaps within the respective stator slots.

4. The electric motor of claim 2, wherein the stator tooth tips adjacent to one another have curved surfaces within the respective stator slots, and the surfaces contact each other to form respective generally semi-circular shaped gaps within the respective stator slots.

5. The electric motor of claim 1, wherein adjacent stator slots have differing shapes from one another.

6. The electric motor of claim 1, wherein adjacent stator tooth tips have differing shapes from one another such that the respective stator slots are non-symmetric.

7. The electric motor of claim 2, wherein the stator tooth tips adjacent to one another have straight surfaces within the respective stator slots, and the surfaces contact each other to form respective generally triangular shaped gaps within the respective stator slots.

8. The electric motor of claim 1, wherein adjacent stator tooth tips are spaced apart from one another such that the respective stator slots are open.

9. The electric motor of claim 8, wherein the stator tooth tips adjacent to one another have curved surfaces which are spaced apart from each other to form respective generally semi-hour glass shaped gaps within the respective stator slots.

10. A stator assembly comprising:
a stator stack;
a plurality of spaced apart stator teeth extending radially from the stator stack, wherein the plurality of stator teeth define a plurality of stator slots;
a plurality of conductors inserted into the stator slots, wherein gaps are formed in the stator tooth slots between the stator teeth and the plurality of conductors; and
wherein the stator teeth each define a stator tooth tip, and wherein the stator tooth tips are integrally formed with the stator teeth and are shaped to reduce the gaps within the stator slot formed between the stator teeth and the plurality of conductors.

11. The stator assembly of claim 10, wherein the conductors are axially inserted within the stator slots.

12. The stator assembly of claim 10, wherein adjacent stator tooth tips are spaced apart from one another such that the respective stator slots are closed.

13. The stator assembly of claim 10, wherein adjacent stator tooth tips have differing shapes from one another such that the respective stator slots are non-symmetric.

15. The stator assembly of claim 13, wherein adjacent stator slots have differing shapes from one another.

16. A method of reducing magnetic flux for a stator assembly comprising:
forming a plurality of stator tooth tips on a plurality of stator teeth for a stator stack, wherein the stator tooth tips are formed to minimize gaps in the stator slots between the stator teeth and a plurality of conductors.

17. The method of claim 16, wherein forming the stator tooth tips includes forming adjacent stator tooth tips into different geometric shapes to form non-symmetric stator slots.

18. The method of claim 16, wherein forming the stator tooth tips includes forming the stator tooth tips to have straight surfaces which are contacting each other such that the respective stator slots are closed with a generally triangular shaped gap.

19. The method of claim 16, wherein forming the stator tooth tips includes forming the stator tooth tips to have curved surfaces which are contacting each other such that the respective stator slots are closed with a generally semi-circular shaped gap.

20. The method of claim 16, wherein forming the stator tooth tips includes forming the stator tooth tips which are spaced apart from each such that the respective stator slots are open.
